(19) United States
(12) Patent Application Publication
(10) Pub. No.: US 2026/0142320 A1
(43) Pub. Date: May 21, 2026

(54) BATTERY UNIT WITH A PLURALITY OF BATTERY CELLS AND A DEVICE FOR PROTECTION AGAINST THERMAL PROPAGATION

(71) Applicant: Volkswagen Aktiengesellschaft, Wolfsburg (DE)

(72) Inventors: Malte COHRS, Wolfsburg (DE); Alexander BOHNSACK, Wolfsburg (DE); Niklas NEUMANN, Wolfsburg (DE)

(73) Assignee: Volkswagen Aktiengesellschaft, Wolfsburg (DE)

(21) Appl. No.: 19/393,988

(22) Filed: Nov. 19, 2025

(30) Foreign Application Priority Data
Nov. 19, 2024 (DE) 10 2024 133 896.2

(51) Int. Cl. H01M 50/383; A62C 3/16; B60L 50/64; H01M 50/209; H01M 50/249; H01M 50/30

(52) U.S. Cl. CPC H01M 50/383; A62C 3/16; H01M 50/209; H01M 50/249; H01M 50/394; B60L 50/64; H01M 2220/20

(57) ABSTRACT

A battery unit with a plurality of battery cells and a device for protection against thermal propagation. The battery unit has a plurality of battery cells which are arranged in a series arrangement, wherein the battery cells each comprise a plurality of battery elements and a battery cell casing surrounding the battery elements and having a degassing opening. A protective device extends along the row arrangement of the battery cells and thereby covers the degassing openings. The protective device has at least one foam material layer and the protective device is materially bonded to the battery cell casings via an adhesive bond.

This nonprovisional application claims priority under 35 U.S.C. § 119(a) to German Patent Application No. 10 2024 133 896.2, which was filed in Germany on Nov. 19, 2024, and which is herein incorporated by reference.

### BACKGROUND OF THE INVENTION

### Field of the Invention

The invention relates to a battery unit with a plurality of battery cells.

### Description of the Background Art

A battery is an electrochemical-based storage device for electrical energy during the discharge of which stored chemical energy is converted into electrical energy by an electrochemical redox reaction. A battery can comprise one or typically multiple battery elements, which, in order to form a battery cell, are arranged within a casing, usually in the form of a film casing or housing, often referred to as a “pouch.” The battery elements can each comprise two electrodes, a separator arranged between the electrodes for electrically separating the electrodes, and an electrolyte serving as an ionic conductor. The two electrodes of a battery element can differ with respect to an active material they each contain, whereby one of the electrodes is anodically active and the other is cathodically active. Furthermore, a battery can typically comprise two battery terminals which are integrated into the casing and which are electrically conductively connected to the electrodes on the inside of the casing. All anodically active electrodes can be connected to one battery terminal and all cathodically active electrodes to the other battery terminal.

For particularly high performance requirements, as is the case for a traction battery of a motor vehicle, for example, a large number of battery cells are combined in one or more battery units, wherein an electrical series and/or parallel connection can be provided for the battery cells. The battery cells of a battery unit are often also mechanically connected to one another.

The battery cells of a motor vehicle, particularly when working together as the traction battery of the motor vehicle comprising an electrified drive train, they are formed with an overall relatively large battery capacity can pose a considerable potential hazard if they are at least partially damaged, for example, due to improper use, internal short circuits, overcharging, overheating, aging, or due to an accident involving the motor vehicle. If a battery cell is damaged, there is namely a risk of a so-called thermal runaway. The overheating of an exothermic chemical reaction or a technical apparatus due to a self-reinforcing, heat-producing process is basically referred to as a thermal runaway; in the case of a battery cell, this can result in particular from an internal short circuit caused by damage. In the case of a battery unit, there is additionally the risk that a thermal runaway of a battery cell will lead to a thermal propagation, i.e., an overheating of the other battery cells as well in the battery unit in the form of a chain reaction.

US 2020/0212384 A1 discloses a battery unit with safety features for reducing the risk of thermal propagation. The battery unit comprises a foam layer having a plurality of cutouts. Moreover, the battery unit can comprise a housing that receives the foam layer and a plurality of battery cells. Furthermore, the housing may contain a ventilation cavity which is in fluid communication with the plurality of cutouts in the foam layer.

CN 117 219 953 A describes a thermal protection plate for use in a housing of a battery unit, wherein the thermal protection panel comprises three layers. A first layer is to be deliberately destroyed when impacted by a hot gas. A core layer can be formed of a foam material. A third layer can be a steel plate.

### SUMMARY OF THE INVENTION

Its therefore an object of the present invention to reduce the risk of thermal propagation in a battery unit.

This object is achieved in a battery unit, a protective device for such a battery unit and a battery system with such a battery unit.

A battery unit according to an example of the invention comprises at least a plurality of battery cells, which may in particular be lithium-ion battery cells and which are arranged in a series arrangement. The battery cells each have a plurality of battery elements. The battery elements each can comprise two electrodes, a separator arranged between the electrodes for electrically separating the electrodes, and an electrolyte serving as an ionic conductor between the electrodes. This electrolyte can be liquid or solid and can also act as a separator, particularly in the case of a solid design. The battery cells furthermore have a battery cell casing surrounding the battery elements. The battery cell casing can preferably be designed as a film casing (so-called “pouch” casing) or as a housing, in particular as a dimensionally stable housing. A housing or generally a structural component can be considered “dimensionally stable” if its three-dimensional shape does not collapse due to its own weight force without an external load. Preferably, such a housing or structural component can be designed to be dimensionally stable such that it does not collapse when exposed to external forces that occur during normal use and, particularly preferably, is also not deformed to a relevant extent. The battery cell casings each have at least one degassing opening, which is preferably closed (in a normal state of the battery cells) by means of a pressure relief valve, preferably in the form of a burst element (e.g., a burst film), which is designed to fail structurally specifically at a defined overpressure (e.g., between 5 bar and 6 bar) within the battery cell casing. The battery cells furthermore can comprise a first battery terminal and a second battery terminal, wherein the battery terminals are provided for the electrical connection of the respective battery cells to an external circuit. For this purpose, the battery terminals can be integrated into the battery cell casing in such a way that a first section thereof is arranged outside the casing and is thus accessible for connection to the external circuit, whereas a second section located inside the battery cell casing is used for an electrical connection to the battery elements. In this regard, a first electrode of the (each) battery element(s) can be electrically connected to the first battery terminal and a second electrode of the (each) battery element(s) to the second battery terminal.

The battery unit of the invention can furthermore comprise a preferably flat protective device which extends along the series arrangement of the battery cells and in this regard (completely) covers the (in particular all) degassing openings, wherein the protective device has at least one foam material layer, preferably formed exclusively of a preferably elastic foam material, i.e., a material with a cellular structure, wherein the cells are hollow. Preferably, it can be provided that the foam has a closed-pore or mixed-cell structure. A closed-pore cell structure substantially comprises only cavities which are spatially separated from each other. Accordingly, the cell walls between the individual cavities are completely closed. A mixed-cell structure, in contrast, comprises both interconnected and spatially separated cavities. The foam material layer can preferably be designed to be closed over the entire surface and furthermore preferably to extend over the entire longitudinal and transverse extent of the protective device. However, the foam material layer should at least completely cover the degassing openings of the battery cells. In the event of a thermal runaway of a battery cell, the foam material layer is to enable degassing of this battery cell via the associated degassing opening, by destroying the foam material layer locally in the region of this degassing opening in a defined way and, in particular, in a relatively resistance-free manner by a gas flow emerging from the battery cell casing via the degassing opening; this thereby enables a reduction of an excess pressure that has formed in this battery cell casing and a discharge of a gas causing this overpressure. In this case, the protective device, and in particular the foam material layer thereof, protect the adjacent battery cells from this gas, which can have a very high temperature, and also from particles contained therein, so that the risk of thermal propagation in the battery unit can be minimized. The locally defined destruction of the foam material layer may also be supported by the fact that the foam material layer has at least one weak point (formed for a defined failure), such as, for example, a preferably slit-shaped, complete, or partial material weakening, at least in the sections covering the degassing openings.

According to the invention, it is provided furthermore that the protective device is materially bonded to the battery cell casings by means of an adhesive bond. Not only can a simple and thus cost-effective assembly of the battery unit be realized thereby, but the protective effect of the protective device with regard to thermal propagation can be increased by the adhesive bond in that infiltration of the protective device by a gas escaping from the degassing opening of one of the battery cells is prevented, as a result of which this gas would otherwise come into contact to at least a reduced extent with the other battery cells and in particular with the associated degassing openings, which may each be sealed with a burst element that can be subjected to only a relatively low thermal and mechanical load.

In order to prevent such an infiltration of the protective device particularly effectively or at least keep it low, it can preferably be provided that the strength of the adhesive bonding (peeling preferably >2 N/cm, particularly preferably >6 N/cm) is higher than a tensile strength of the foam material layer, so that it is ensured that the foam material layer fails or is destroyed specifically in the area of the degassing opening of a thermally continuous battery cell before a relevant loosening of the adhesive bond occurs in the area surrounding this degassing opening.

In order to be able to exert an advantageous protective effect with regard to thermal propagation, it can preferably be provided that the foam material layer is flame-retardant and preferably self-extinguishing. In particular, it can have a flammability of class V-1, preferably class V-0 (according to DIN EN 60695-11-10 and -20).

Furthermore, the foam material layer can preferably have a relatively high compressibility at least in the vertical direction of, for example, at least 50%, preferably of at least 75%, for example, 80%. As a result, the foam material layer can advantageously compensate for shape and position tolerances in the battery unit and/or have a relatively good sealing effect.

Furthermore, it can preferably be provided that the protective device, and in particular the foam material layer, may have an electrically insulating effect, whereby electrical separation of the individual battery cell casings, which may be electrically charged, can be achieved.

Preferably, it can be provided that the foam material layer can be formed (partially or completely) from at least one silicone (or polyorganosiloxane) and/or a synthetic rubber (e.g., EPDM (ethylene propylene diene rubber)) and/or a polyurethane (PUR) and/or a polyolefin (PO). By using at least one of these materials, the requirements placed on the foam material layer can be advantageously realized. At least one flame-retardant additive can preferably be a component of the foam material layer.

Furthermore, it can be preferably provided that the adhesive bond can be formed via a pressure-sensitive adhesive (highly viscous liquid; preferably in the form of a transfer adhesive tape or a double-sided coated adhesive tape) and/or by means of a non-metallic process material that adhesively bonds substrates. Pressure-sensitive adhesives comprise a permanently tacky material that forms an adhesion to various surfaces under light pressure. Such an adhesive bond shows advantageous properties with regard to the intended use in a battery unit of the invention. In particular, a pressure-sensitive adhesive (in particular on an acrylate base and/or silicone base and/or rubber base) can be advantageously suitable for ensuring bonding of the foam material layer to the battery cell casings with the required strength.

At least one adhesive can be arranged on both sides of a carrier layer to form the adhesive bond, wherein the carrier layer (with the adhesive) is arranged between the foam material layer and the battery cell casings. The carrier layer can be designed as a film, for example. A “film” is a flexible and thus easily deformable body whose length and width (which limit the large areas of the films) are many times greater than its height (i.e., the thickness of the film), wherein the height can preferably correspond to a maximum of 1/100 or 1/500 or 1/1000 or 1/10,000 or 1/100,000 of the length and/or width of the film. In particular, a film can be dimensioned with such a small film thickness that it would be noticeably deformed by its own weight force without support.

A relatively simple assembly of the battery unit and, in particular, advantageous handling of the protective device can be realized by the use of such a carrier layer. On the other hand, such a carrier layer can negatively influence the failure behavior of the protective device in the area of the degassing openings, so that it can be advantageous if such a carrier layer is not used and thus only an adhesive is arranged between the foam material layer and the battery cell casing. Alternatively, however, it can also be provided that the carrier layer has a (defined failure) weak point, such as, for example, a preferably slit-shaped, complete, or partial material weakening, at least in the sections covering the degassing openings. An advantageously usable carrier layer can also be designed in a net-like manner and thus with a large number of relatively large through-openings, preferably forming at least 50% of the total area of the carrier layer.

The protective device can have an additional layer on the foam material layer side facing away from the battery cells. The additional layer can preferably be made of PET (polyethylene terephthalate) or at least comprise PET. Furthermore, the additional layer can preferably be designed as a film, in particular as an adhesive film (single-sided adhesive tape). The additional layer can bring about, for example, a structural reinforcement of the foam material layer. Alternatively or in addition, the additional layer can also create a seal or prevent the penetration of moisture into the foam material of the foam material layer. In order to prevent the additional layer from negatively influencing the failure behavior of the protective device in the area of the degassing openings, it can be provided that the additional layer has a (defined failure) weak point, such as, for example, a preferably slit-shaped, complete, or partial material weakening, at least in the sections covering the degassing openings.

The protective device furthermore can have a reinforcing layer on the foam material layer side facing away from the battery cells, wherein the reinforcing layer has at least one through-opening at least in a section covering the degassing openings of the battery cells. The reinforcing layer can serve to structurally reinforce the protective device or the battery unit as a whole. For this purpose, it can preferably be made of metal and/or be designed to be dimensionally stable.

If a battery unit of the invention has both an additional layer and a reinforcing layer, it can preferably be provided that the additional layer can be arranged between the foam material layer and the reinforcing layer.

Further, a preferably closed circumferential edge region of the foam material layer can be covered by an edge section of the reinforcing layer, the edge section may delimit the at least one through-opening, whereby an advantageous support of the foam material layer can be realized in at least one region located outside an overlap with the degassing openings. Furthermore, it can then preferably be provided that an annular sealing and/or adhesive element, for example, applied as an annular track of a pasty sealant and/or adhesive, can be arranged in this edge section on the reinforcing layer side facing the foam material layer. This sealing and/or adhesive element can advantageously achieve a seal or prevent the penetration of moisture through the at least one through-opening into the protective device and to the battery cells. Alternatively or in addition, the sealing and/or adhesive element can also improve the structural strength of the protective device and the battery unit as a whole. The preferably provided additional layer can also ensure advantageous adhesive adherence of the sealing and/or adhesive element to the foam material layer in such a battery unit design. This can be the case in particular if it is (also) made of silicone, because silicone is otherwise difficult to bond due to its low surface energy.

The invention also relates to a protective device for a battery unit with the features which define the protective device and are mentioned in the description and the patent claims.

Furthermore, the invention relates to a battery system with one or more battery units of the invention and a battery system housing in which the battery unit(s) is/are fixedly received. The reinforcing layer(s) of the battery unit(s) can preferably form a housing base of the battery system housing.

The invention also relates to a motor vehicle, in particular an electric motor vehicle with such a battery system. In particular, the battery system can be a traction battery or at least a part of such a traction battery of the electric motor vehicle. An “electric motor vehicle” is a motor vehicle that comprises at least one electric traction motor which makes possible the sole propulsion of the motor vehicle. In this regard, the motor vehicle can exclusively comprise the at least one electric traction motor as a drive motor (“electric vehicle”) or the at least one electric traction motor can be provided in addition to another drive device, in particular an internal combustion engine (“hybrid vehicle”). The motor vehicle can be in particular a wheel-based and non-rail-bound motor vehicle (preferably a passenger car or a truck).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a floor assembly of a motor vehicle;

FIG. 2 shows a battery system, according to the invention, of the motor vehicle;

FIG. 3 shows a battery cell of the battery system;

FIG. 4 shows a longitudinal section through the battery cell;

FIG. 5 shows a section of a cross section through the battery system;

FIG. 6 shows a section of a cross section through the battery system;

FIG. 7 shows a protective element for a battery system of the invention according to an example;

FIG. 8 shows a protective element for a battery system of the invention according to an example;

FIG. 9 shows a protective element for a battery system of the invention according to an example;

FIG. 10 shows a protective element for a battery system of the invention according to an example;

FIG. 11 shows a protective element for a battery system of the invention according to an example;

FIG. 12 shows a protective element for a battery system of the invention according to an example;

FIG. 13 shows an example of the protective element according FIG. 8 with slit-shaped weak points which completely penetrate a foam material layer of the protective element;

FIG. 14. shows an example of the protective element according to FIG. 8 with weak points only partially penetrating the foam material layer (on a first side); and

FIG. 15 shows an example of the protective element according to FIG. 8 with weak points only partially penetrating the foam material layer (on a second side).

### DETAILED DESCRIPTION

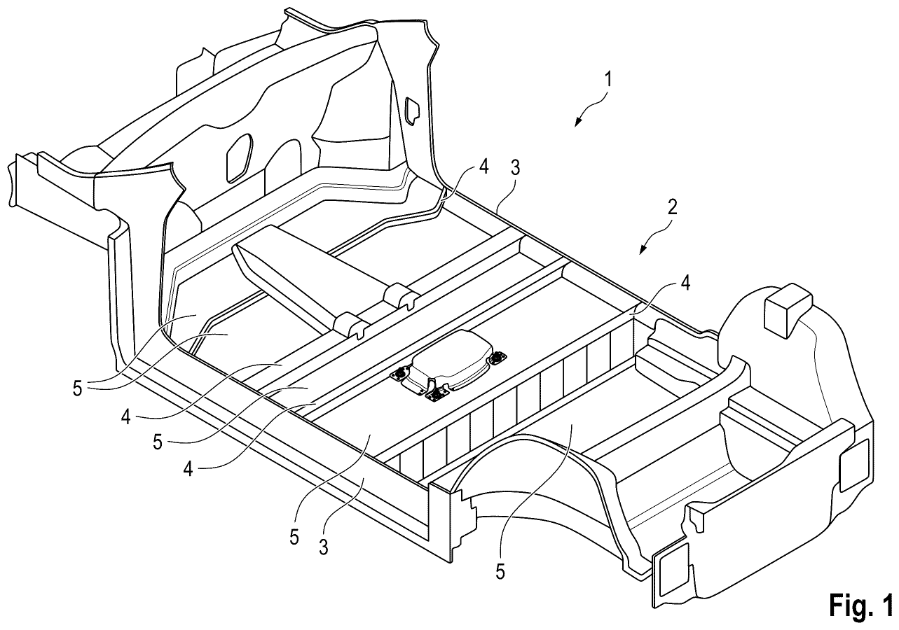

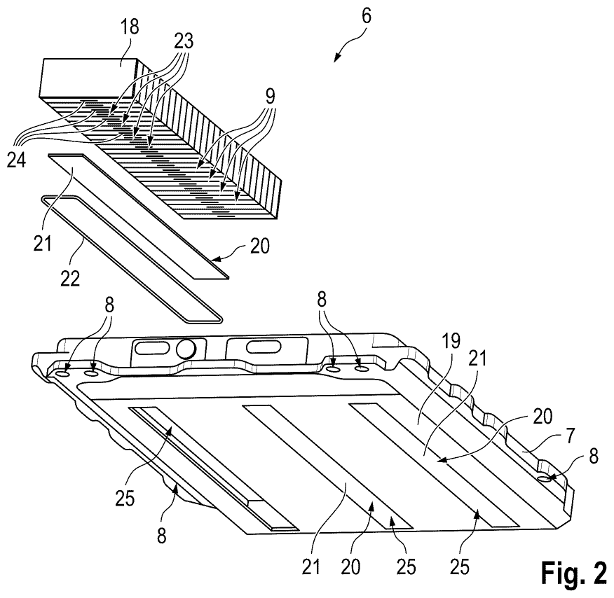

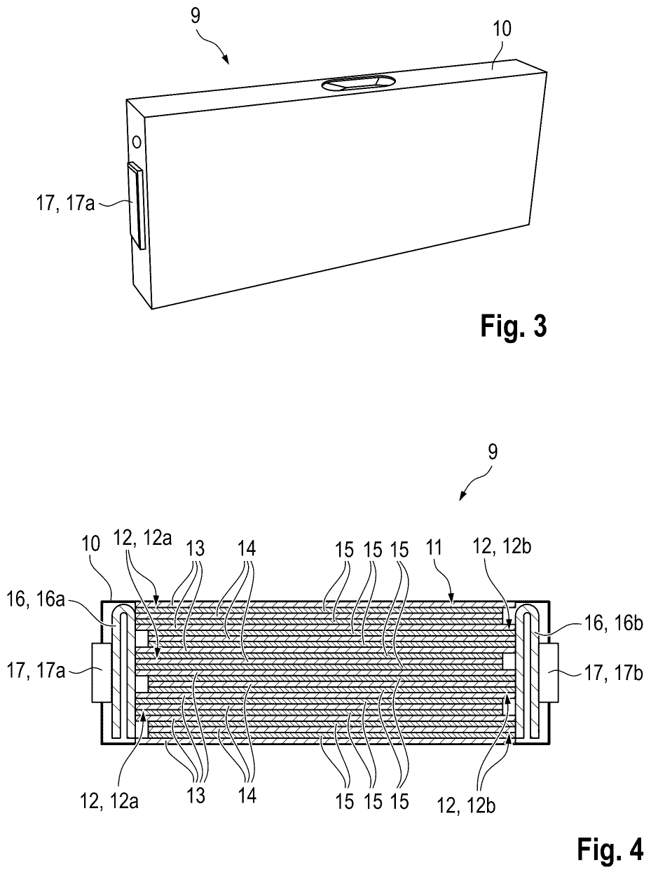

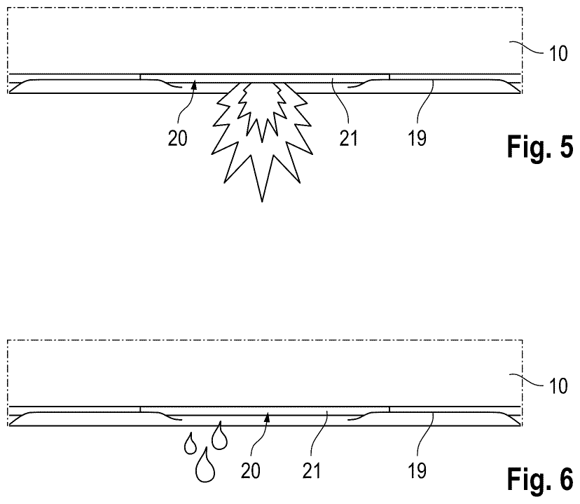

FIG. 1 shows a floor assembly 1, which is part of a body for an electric motor vehicle. As is known, floor assembly 1 provides, among other things, attachment points for components of a chassis and a drive train of the motor vehicle and can be manufactured at least partially from formed metal sheets. The section of the floor assembly located between two axles of the motor vehicle is referred to below as intermediate floor 2. This intermediate floor 2 is formed, among other things, by longitudinal members 3, cross members 4, and floor panels 5, wherein these components delimit a receiving space, which is provided for receiving a (traction) battery system 6 (cf. FIGS. 2 and 5) of the motor vehicle. This receiving space and thus battery system 6 are located underneath floor panels 5 of intermediate floor 2, wherein a flat body structure serving as underride protection is arranged additionally underneath battery system 6.

Battery system 6 is shown in FIG. 2. It has a battery system housing which comprises a holding frame 7 which forms connecting openings 8 via which holding frame 7 and thus battery system 6 are or can be connected to longitudinal members 3 and cross members 4 of intermediate floor 2. The battery system housing furthermore comprises a housing base 19 and a housing cover. A large number of battery cells 9 are arranged inside the battery system housing; the cells are electrically interconnected in order to be able to provide, in combination (as a traction battery), a sufficiently large electrical power for driving the motor vehicle to an electric traction motor of the motor vehicle.

Battery cells 9 are designed as so-called prismatic battery cells 9 and therefore have a rectangular battery cell housing 10, which can be made of a metal (e.g., aluminum), for example. Battery cell housing 10 can be provided with a functional layer on the outside, in particular an (electrically insulating) insulation layer.

Battery elements are received in battery cell housing 10 (cf. FIG. 4). Specifically, the battery elements are stacked in the form of an electrode-separator composite (ESV) 11.

Further, a wound arrangement of the battery elements can also be provided, however. The ESV 11 comprises an alternating arrangement of a plurality of first electrodes 12a, which act as anodes when battery cell 9 is discharged, and a plurality of second electrodes 12b, which act as cathodes when battery cell 9 is discharged. As a result of the alternating arrangement of electrodes 12, a first electrode 12a is arranged between two second electrodes 12b and a second electrode 12b is arranged between two first electrodes 12a, with the exception of the two electrodes 12 located on the outside of the stack or the ESV 11. In this regard, neighboring electrodes 12 are each spatially separated by a separator 13 and therefore also electrically insulated from each other. In each case, a first electrode 12a and a second electrode 12b as well as a separator 13 arranged between them, which is impregnated with an electrolyte, form a battery element. Conduction of ions between neighboring electrodes 12 via separator 13 located between them is made possible by the electrolytes.

Each electrode 12 comprises a flat, film-shaped substrate 14, which can be made of copper, for example, in the case of first electrodes 12a provided as anodes, and of aluminum in the case of second electrodes 12b provided as cathodes. In a rectangular section thereof, the two large surfaces of each electrode 12, which surfaces are located in the stacking direction of the ESV 11, are provided with a coating of an active material 15 to enable the various electrodes 12a, 12b to act as anodes or cathodes during use of battery cell 9. These and the correspondingly rectangular separators 13 are stacked at least in the area of these rectangular sections of substrates 14 and thus electrodes 12, which results in the rectangular shape of the ESV 11.

On one transverse side of the rectangular section of each electrode 12, an area of substrate 14 is provided in which it is not provided with the coating of the respective active material 15. This area of electrodes 12 in each case serves as a current collector 16, via which the individual electrodes 12 are directly or indirectly connected to an associated battery terminal 17 of battery cell 9 in an electrically conductive manner. In this regard, current collectors 16a of all first electrodes 12a are connected to a first (17a) of battery terminals 17 and current collectors 16b of all second electrodes 12b are connected to a second (17b) of battery terminals 17.

Battery cell housing 10 of battery cells 9 each have a degassing opening 23 in a central section of one of their longitudinal sides, which opening is covered by a film-shaped burst element 24, serving as a pressure relief valve, and closed thereby. Burst element 24 is provided and designed in each case so that in the event of thermal runaway of the battery elements uncontrolled bursting of battery cell housing 10 is avoided in that a gas, which forms inside battery cell housing 10 as a result of the thermal runaway and which leads to a relatively large increase in pressure, is discharged into the environment via the deliberately rupturing burst element 24.

Battery cells 9 of battery system 6 are divided into a total of three battery cell groups, each of which is received in a row arrangement in a support structure 18 of battery system 6. An intermediate cell layer is arranged between every two battery cells 9.

The battery cell groups with the associated support structure 18 and a protective device each form a battery unit of the invention.

The protective device in each case comprises a protective element 20, which comprises at least one foam material layer 21, an annular sealing and adhesive element 22, and an associated section of housing base 19 of the battery system housing (as a reinforcing layer of the respective battery unit).

The rectangular, flat protective element (i.e., with a relatively small height extent compared to the longitudinal and width extents) extends along the entire row arrangement of battery cells 9, wherein it covers the degassing openings of all battery cells 9 of the battery unit. Degassing openings 23 of battery cells 9 of the individual battery units and thus also a central section of the respective associated protective element 20 in the assembled state of the battery system are arranged in the region of a respective elongated through-opening 25 of housing base 19 of the battery system housing. This enables the gas escaping from this battery cell 9 to be discharged from the battery system housing via the associated through-opening 25 of housing base 19 in the event of a thermal runaway of one of the battery cells 9 and the resulting destruction of the associated burst element 24 and the adjacent section of protective element 20 (cf. FIG. 5). This minimizes the risk that this escaping gas, which has a very high temperature and can also carry particles, can damage the adjacent battery cells 9 and thus lead to thermal propagation.

An overflow of this gas from the area of degassing opening 23 of the thermally continuous battery cell 9 to the adjacent battery cells 9 is prevented as reliably as possible by the fact that protective element 20 is bonded to battery cell housings 10 and is additionally braced or compressed in a closed circumferential edge section between battery cell housings 10 and housing base 19 of the battery system housing. Sealing and adhesive element 22 is also braced or compressed in this edge area between protective element 20 and housing base 19 and effectively seals the gap formed between these components. This seal prevents not only the overflow of gas escaping from a thermally continuous battery cell 9 to the neighboring battery cells 9, but also a penetration of moisture from the environment into the battery system housing (cf. FIG. 6), which is of particular importance because the underside of the battery system housing, as described, forms a section of the underside of the motor vehicle and may only be covered by the body structure, which serves as underride protection, wherein, however, this cover may not designed to be completely sealing.

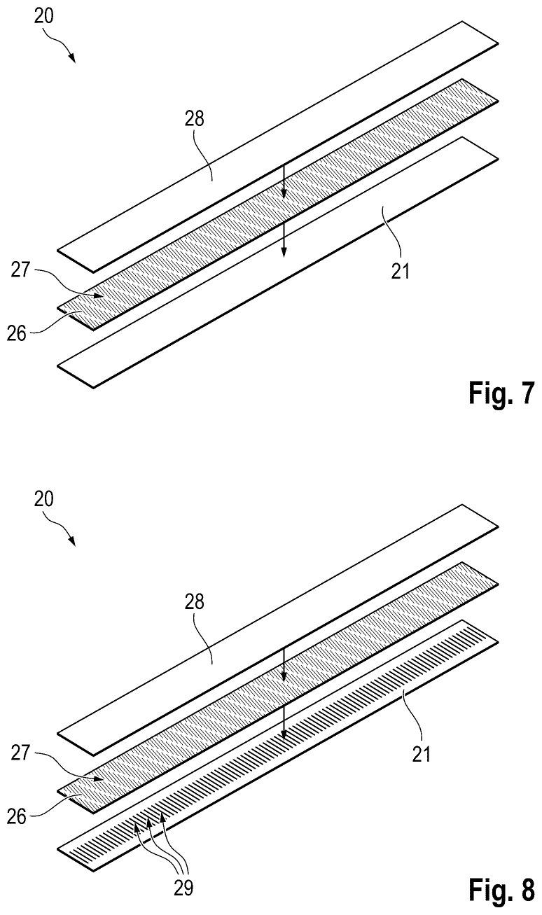

FIGS. 7 to 13 show different examples of protective element 20.

Protective element 20 according to FIG. 7 comprises foam material layer 21 and a carrier layer 26, which is provided on both sides with a layer of an adhesive 27 over the entire surface, in order to bond foam material layer 21 to the adjacent sections of battery cell housings 10. Also shown is a film-like separating layer 28, which in an initial state of protective element 20, i.e., before bonding to battery cell housings 10, is arranged on the carrier layer 26 side, facing away from foam material layer 21, and serves as protection for the adhesive 27 arranged there. Before protective element 20 is bonded to battery cell housings 10, this separating layer 28 is removed to enable an adhesive effect of the adhesive to battery cell housings 10.

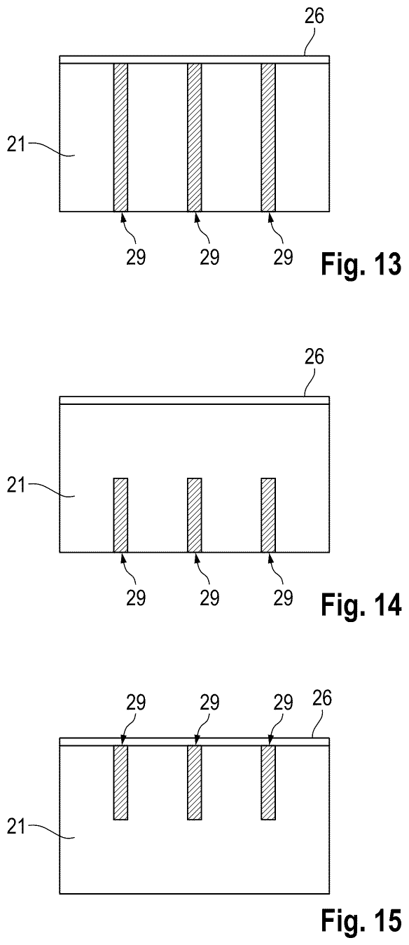

Protective element 20 shown in FIG. 8 differs from that shown in FIG. 7 in that foam material layer 21 is designed with a large number of slit-shaped weak points 29, wherein these weak points 29 or slits penetrate foam material layer 21 completely or partially (with regard to the height extent; see FIGS. 13 to 15). The slit-shaped weak points 29 run in the transverse direction of foam material layer 21 or protective element 20 as a whole.

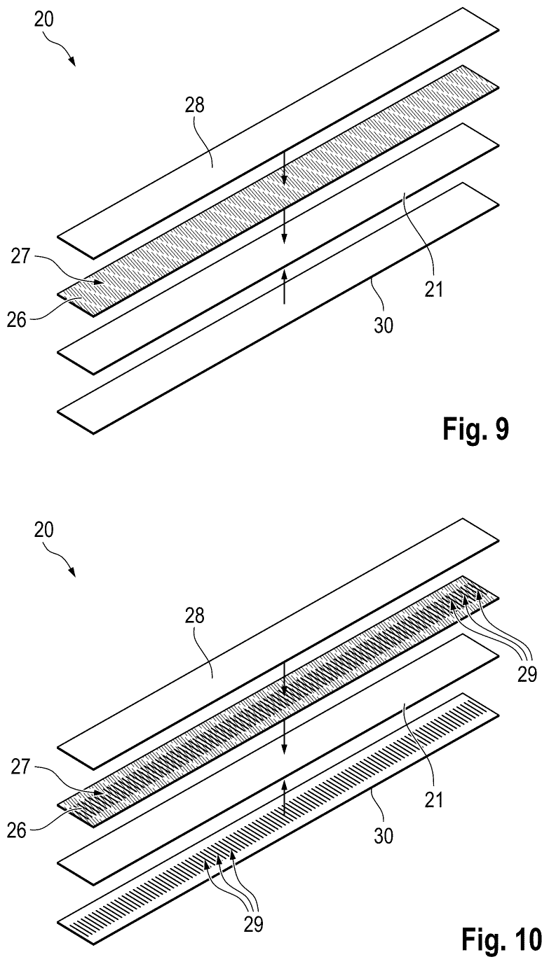

Protective element 20 shown in FIG. 9 differs from that according to FIG. 7 in that on the foam material layer 21 side, facing away from carrier layer 26 and facing the housing base 19 of the battery system housing, an additional layer 30 is provided by means of which in particular a highly effective sealing of the battery system can be achieved with regard to the penetration of moisture via through-openings 25 of housing base 19 of the battery system housing. This additional layer 30, which can be made of PET, for example, can in particular also interact advantageously with sealing and adhesive element 22 in order, among other things, to realize an advantageous adhesive effect between these components and thus between the protective element and housing base 19.

Protective element 20 according to FIG. 10 also comprises such an additional layer 30, wherein, in deviation from the example according to FIG. 9, both carrier layer 26 and additional layer 30 are designed with a plurality of slit-shaped weak points 29 extending in the transverse direction of protective element 20.

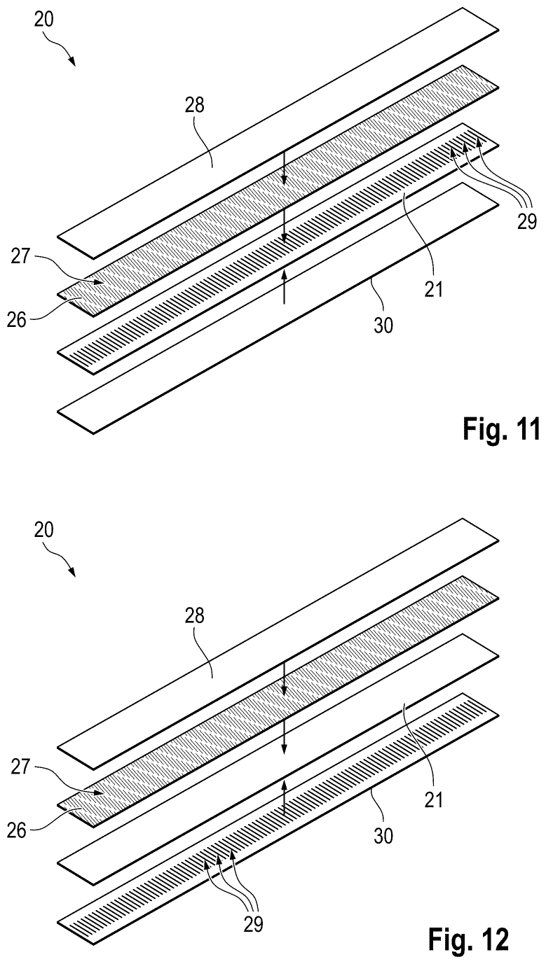

Protective element 20 according to FIG. 11 differs from that according to FIG. 8 in an additionally present additional layer 30 without weak points 29, as is also provided in the protective element 20 according to FIG. 9.

Protective element 20 according to FIG. 12 differs from that according to FIG. 9 in that additional layer 30 is designed with a plurality of slit-shaped weak points 29 running in the transverse direction of protective element 20.

Instead of carrier layer 26 (with or without weak points 29), in all or some examples, only a layer of adhesive 27 can be provided, which preferably covers the entire surface of the adjacent side of foam material layer 21.

With the exception of the optionally present weak points 29, the various layers of the shown protective elements 20 are preferably designed to cover the entire surface and thus be free of openings.

As shown, the various layers of protective elements 20 can each have large rectangular surfaces, which can also have the same dimensions. Exemplary dimensions of the large surfaces can be: length: 1100 mm to 1200 mm; width: 100 mm to 150 mm. However, it can be advantageous for separating layer 28 if it has an oversize with respect to the longitudinal and/or transverse extent compared to at least carrier layer 26 (if present) and/or foam material layer 21 in order to simplify removal before bonding to battery cell housings 10. The slit-shaped weak points can have a slit length of 65 mm, for example. The distances between these weak points 31 can be 8 mm, for example.

The foam material of foam material layers 21 can preferably be formed of silicone, synthetic rubber, PUR, or PO. An advantageous layer thickness (extension in the height direction) of foam material layer 21 can be 3.5 mm to 4 mm, for example.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery unit comprising:
at least two battery cells arranged in a row arrangement, wherein the at least two battery cells each comprise a plurality of battery elements and a battery cell casing surrounding the battery elements and comprise a degassing opening; and
a protective device that extends along the row arrangement of the at least two battery cells and thereby covers the degassing openings, the protective device having at least one foam material layer,
wherein the protective device is materially bonded to the battery cell casings via an adhesive bond.

2. The battery unit according to claim 1, wherein a strength of the adhesive bond is higher than a tensile strength of the foam material layer.

3. The battery unit according to claim 1, wherein the foam material layer has a flammability of class V-1 or V-0 according to DIN EN 60695-11-10 and -20 and/or is electrically insulating.

4. The battery unit according to claim 1, wherein the foam material layer is formed partially or completely from a silicone and/or a synthetic rubber and/or a polyurethane and/or a polyolefin and/or comprises a flame-retardant additive.

5. The battery unit according to claim 1, wherein the adhesive bond is formed via a pressure-sensitive adhesive.

6. The battery unit according to claim 1, wherein at least one adhesive is arranged on both sides of a carrier layer to form the adhesive bond, or only an adhesive is arranged between the battery cell casings and the foam material layer.

7. The battery unit according to claim 1, wherein the protective device has an additional layer on the foam material layer side facing away from the battery cells.

8. The battery unit according to claim 7, wherein the additional layer is made of PET.

9. The battery unit according to claim 1, wherein the protective device has a reinforcing layer on the foam material layer side facing away from the battery cells, wherein the reinforcing layer has at least one through-opening at least in overlap with the degassing openings of the battery cells.

10. The battery unit according to claim 9, wherein an edge region of the foam material layer is covered by an edge section of the reinforcing layer, the edge section delimiting the at least one passage opening.

11. The battery unit according to claim 10, wherein a sealing and/or adhesive element is arranged in the edge section on the reinforcing layer side facing the foam material layer.

12. The battery unit according to claim 1, wherein the foam material layer and/or the additional layer and/or the carrier layer have at least one defined weak point, which is arranged in a section covering at least one of the degassing openings.

13. A protective device comprising:
a section that extends along a row arrangement of at least two battery cells and thereby covers degassing openings formed in the at least two battery cells; and
at least one foam material layer,
wherein the protective device is materially bonded to battery cell casings of the at least two battery cells via an adhesive bond.

14. A battery system comprising:
one or more battery units according to claim 1; and
a battery system housing in which the one or more battery units are fixedly received.

15. The battery unit according to claim 9, wherein the reinforcing layer of the battery unit forms a housing base of a battery system housing.
